(19) United States
(12) Patent Application Publication
(10) Pub. No.: US 2025/0123135 A1
(43) Pub. Date: Apr. 17, 2025

(54) WATER INGRESS APPARATUS AND METHODS OF MAKING AND USING THE SAME

(71) Applicant: Jason Underwood, Chandler, OK (US)

(72) Inventor: Jason Underwood, Chandler, OK (US)

(21) Appl. No.: 18/917,742

(22) Filed: Oct. 16, 2024

Related U.S. Application Data
(60) Provisional application No. 63/590,554, filed on Oct. 16, 2023.

(51) Int. Cl. G01F 23/04

(52) U.S. Cl. CPC G01F 23/04

(57) ABSTRACT

The presently disclosed and/or claimed inventive concepts generally relate to an apparatus and methods of making and using the same for determining the presence of water ingress into a system and the amount of such water ingress. In certain embodiments, the apparatus comprises a reversible color-changing polymer composition that can react with water and thereafter change from a first color to a second color. When the water is thereafter removed, the reversible color-changing polymer composition substantially reverts to the first color. As such, a reusable water gauge device and methods of making and using the same are disclosed.

### CROSS-REFERENCE TO RELATED APPLICATIONS & INCORPORATION BY REFERENCE STATEMENT

This application claims benefit of and priority under 35 USC § 119 (e) of U.S. Provisional Application No. 63/590,554, filed Oct. 16, 2023. The entire contents of each above-referenced patent application(s) is hereby expressly incorporated by reference in their entirety as if expressly set forth herein.

### BACKGROUND

The presently disclosed and/or claimed inventive concepts generally relate to an apparatus and methods of making and using the same for determining the presence of water ingress into a system and the amount of such water ingress. In one embodiment, the system may be an oil storage tank, for example. In one embodiment, the apparatus is a water level gauge, while in yet another embodiment, the apparatus is a coating composition applied to a substrate. In the embodiment where the apparatus is a water level gauge, the water level gauge may be a physical item, such as a probe, tape measure, or other device capable of being placed into a container, wherein the physical item is coated with a composition that reversibly reacts with water to provide a visible indication of the presence (or lack thereof) and amount of water in the container. In yet another embodiment, the physical item may be a composite of one or more polymer layers placed on a substrate that reversibly interact to indicate the presence (or lack thereof) and amount of water in the container.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and particular views of the figures may be shown exaggerated, scaled, or schematically in the interest of clarity and conciseness. Not every component may be labeled in every drawing. In the drawings:

FIG. 1 is a side elevational view of a crude oil or petroleum above-ground storage tank.

FIG. 2 is a cross-sectional view of the storage tank shown in FIG. 1. The tank contains a layer of oil sitting on top of a layer of water.

FIG. 3 is the cross-sectional view of the storage tank shown in FIG. 2, with one embodiment of a water level gauge disclosed herein installed within the tank.

FIG. 4 is the cross-sectional view of the storage tank and installed water level gauge shown in FIG. 3, but a portion of a tape measure included in the water level gauge has changed color in response to contact with the water.

FIG. 5 is a top plan view of a water level gauge known in the art.

FIG. 6 shows an operator holding the water level gauge, as shown in FIG. 5.

FIG. 7 is a view of an operator lowering the water level gauge shown in FIG. 5 into the tank through a hatch at the top of the tank.

FIG. 8 is a view of an operator putting gel on the tape measure of the water level gauge shown in FIG. 5.

FIG. 9 shows an operator continuing to put gel along the tape measure length included in the water level gauge shown in FIG. 5.

FIG. 10 is a view of an operator wiping the gel from the tape after the tape had been lowered into the tank.

### DETAILED DESCRIPTION

Before explaining at least one embodiment of the present disclosure in detail, it is to be understood that the present disclosure is not limited in its application to the details of construction and the arrangement of the components or steps or methodologies set forth in the following description or illustrated in the drawings. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings commonly understood by those of ordinary skill in the art. Further, unless otherwise required by context, singular terms shall include pluralities, and plural terms shall include the singular.

All of the apparatuses, articles, and/or methods disclosed herein can be made and executed without undue experimentation in light of the present disclosure. While the articles and methods of the present disclosure have been described in terms of preferred embodiments, it will be apparent to those skilled in the art that variations may be applied to the articles and/or methods and in the steps or in the sequence of steps of the method described herein without departing from the concept, spirit, and scope of the present disclosure. All such similar substitutes and modifications apparent to those skilled in the art are deemed to be within the spirit, scope, and concept of the present disclosure.

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.”

Throughout this application, the term “about” is used to indicate that a value includes the inherent variation of error for the device, the method being employed to determine the value or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items. It is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that, typically, there is no limit on the number of items or terms in any combination unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The terms “associate,” “associated,” and/or “associated with,” as used herein, will be understood to refer to the direct or indirect connection of two or more items.

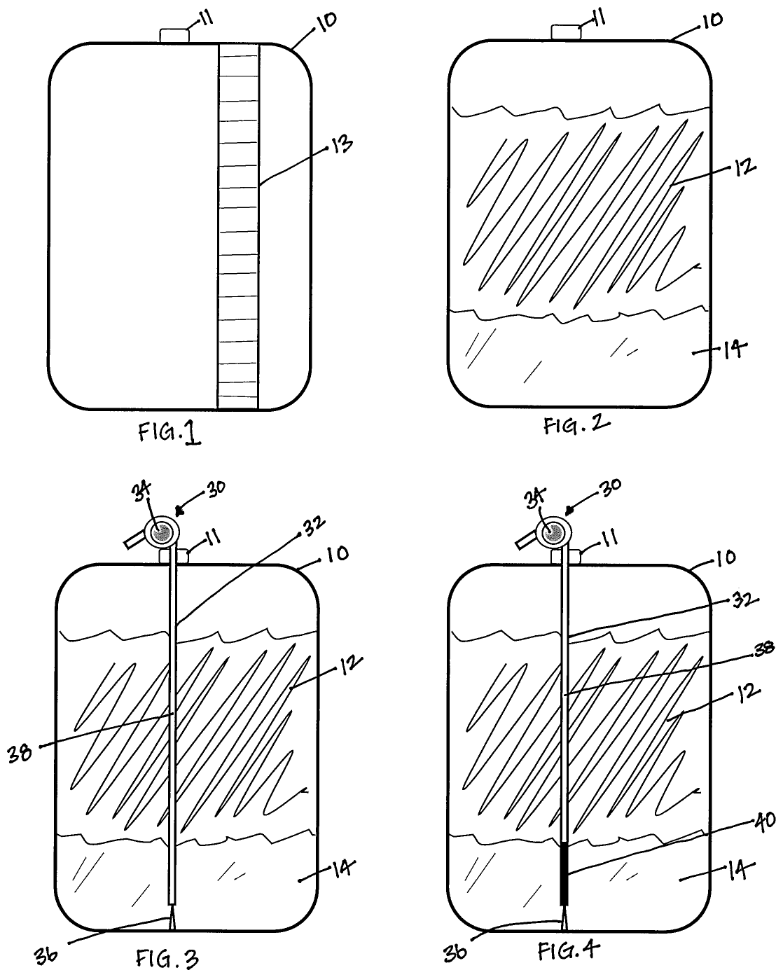

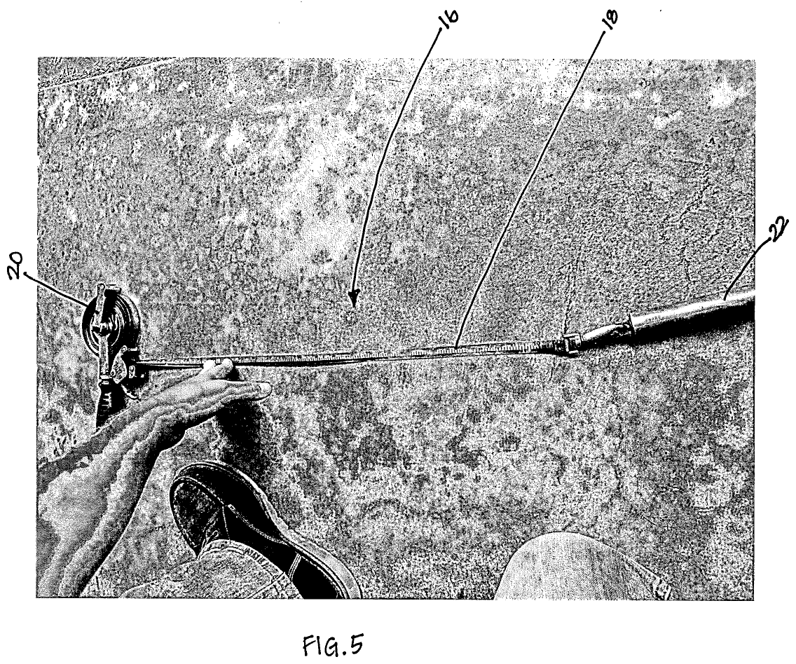

Crude oil or petroleum is commonly stored in large above-ground storage tanks, such as tank 10, shown in FIGS. 1-4 and 6-10. The interior of tank 10 is accessible through a hatch 11, supported on the top of tank 10, and reached via a ladder 13. There is often water mixed in the pumped oil, which separates after entering the storage tank, as shown, for example, by oil 12 and water 14 in FIGS. 2-4. Water can also enter storage tanks through condensation due to rapid changes in the outside temperature and humidity levels or exposure to significant amounts of rainwater. Water in storage tanks can lead to oil degradation or harmful microbial activity. As a result, water must be removed from storage tanks without removing the valuable oil or petroleum. Significant expenses can occur if water is not removed from the storage tank. For example, production owners may lose considerable profit if the oil degrades and is unusable or loads of oil that contain water may be turned away. Production owners may also be fined if the storage tank is found to contain water.

In order to remove the water from the storage tank, the volume of water within the storage tank must be known. The volume of water within the tank can be calculated if the height of the water or water level within the tank is determined.

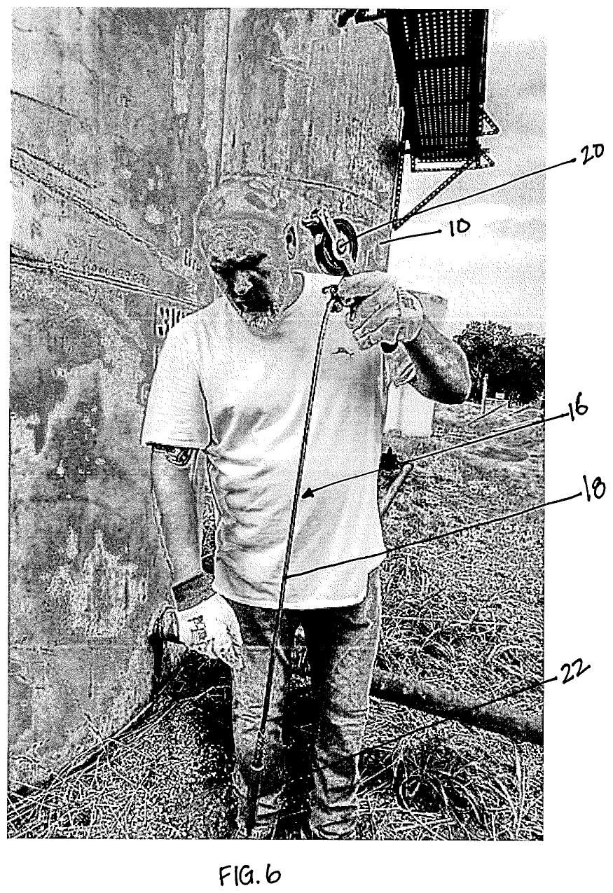

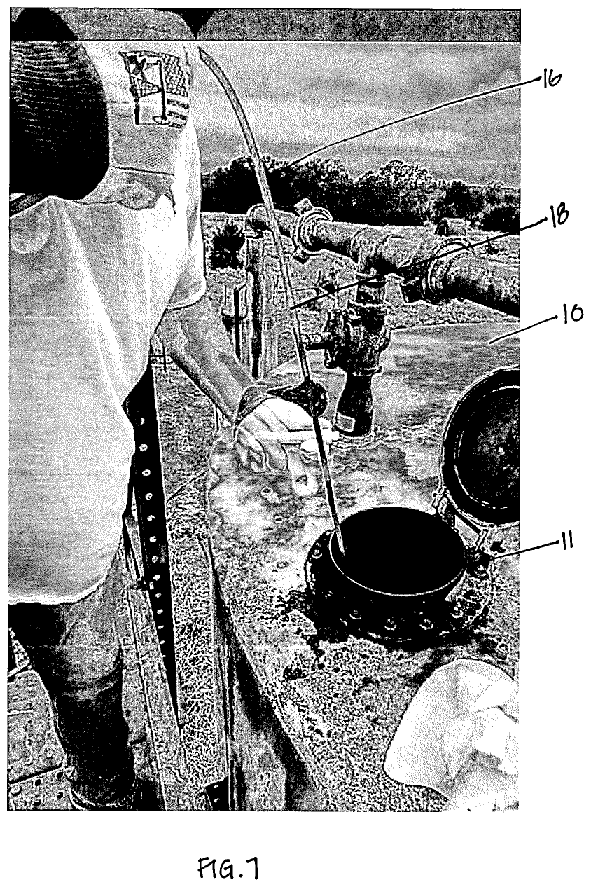

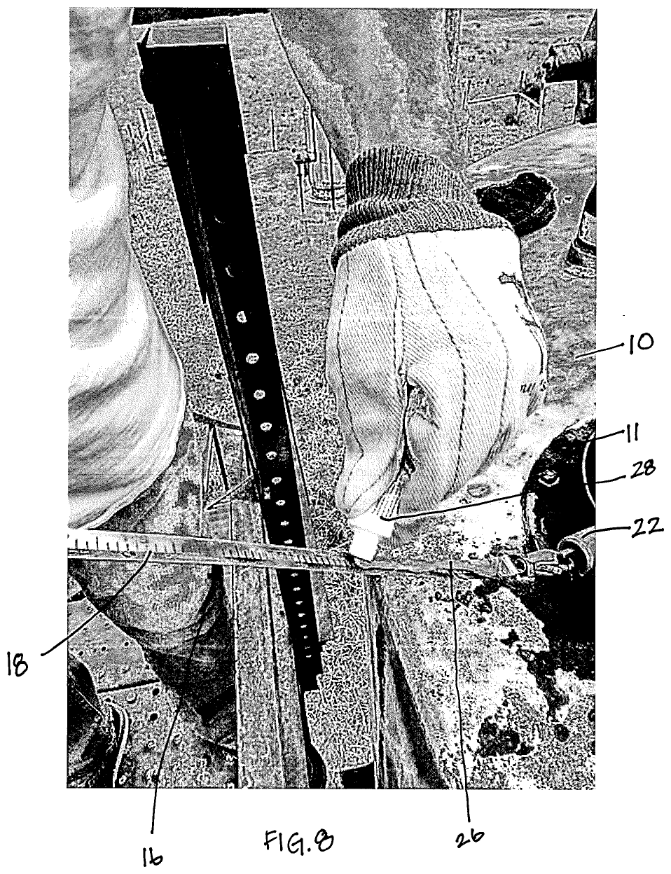

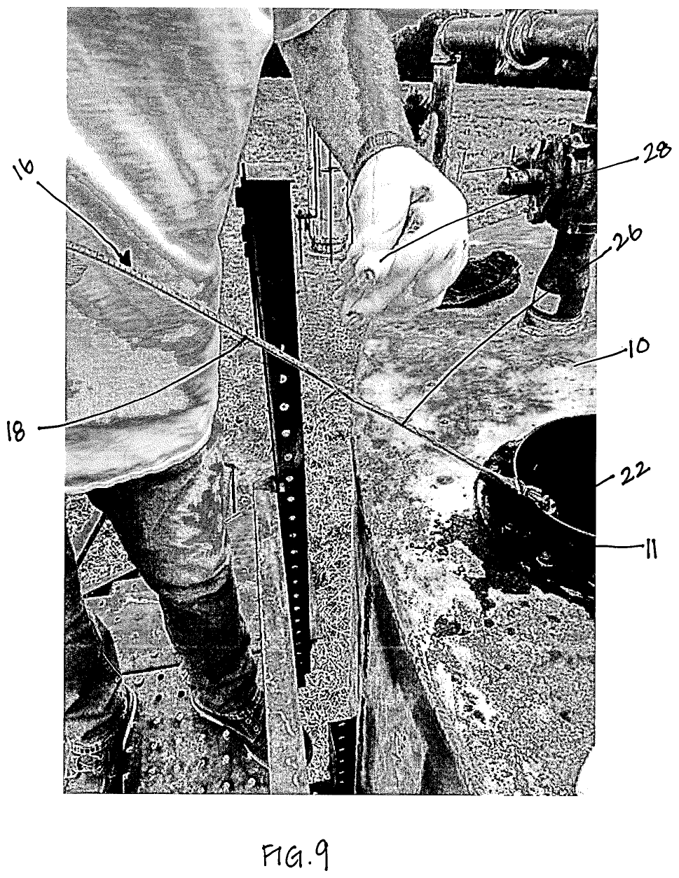

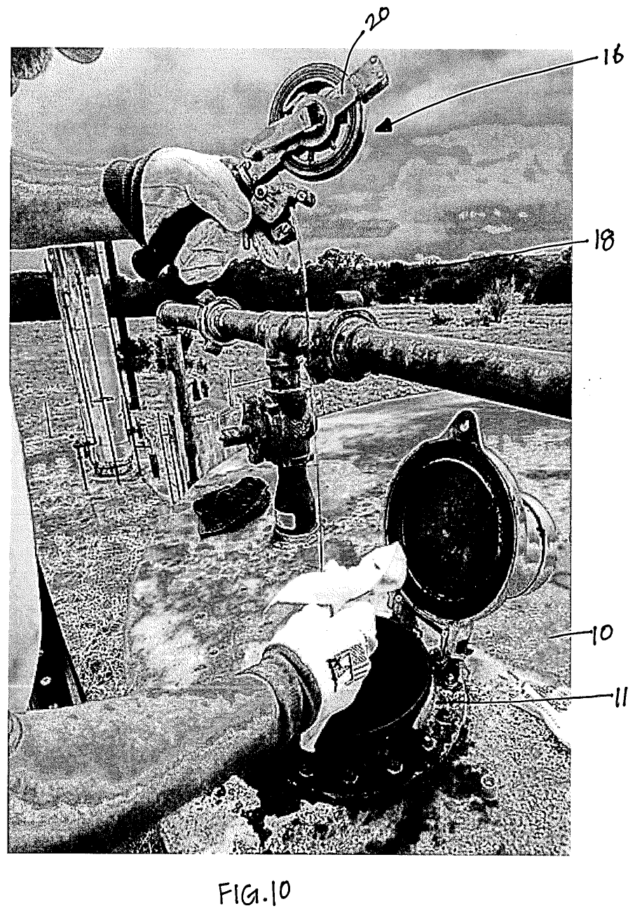

One method known in the art of determining the water level within the tank is by using a water level gauge 16, as shown, for example, in FIGS. 5-10. In the embodiment shown in FIGS. 5-10, water level gauge 16 comprises a tape measure 18 wound around a reel 20 having a weight 22 attached to one of its starting ends, as shown in FIGS. 5 and 6. To determine the water level, an operator lowers tape measure 18 to the bottom of tank 10 through hatch 11 on the top of tank 10, as shown in FIG. 7. Before lowering the tape measure 18 to the bottom of tank 10, a gel 26, known in the art as SAR-GEL® (Sartomer), is applied to the tape measure 18, as shown in FIGS. 8 and 9. The gel 26 is squeezed from a toothpaste-like tube 28 and sticks to the tape measure 18. Upon contact with water, the gel 26 turns a different color. When tape measure 18 is retracted from tank 10, an operator can determine the water level by finding the height on tape measure 18 at which gel 26 starts to turn a different color.

This method is known to be messy and, in many cases, unreliable. For example, if the entire length of gel 26 turns a different color, the gel 26 needs to be wiped away, as shown in FIG. 10, and applied again for a greater length of tape measure 18. As another example, an operator may also incorrectly determine where or if the change in color of gel 26 occurs, thereby resulting in an erroneous measurement of water.

Turning back to FIGS. 3 and 4, one embodiment of the presently disclosed and claimed inventive concept(s) is directed to an apparatus and method of using this apparatus to determine the water level within tank 10 without using gel 26 or without applying any substance to a tape measure or other device lowered into tank 10. In this embodiment, a novel water level gauge 30 is provided that encompasses a reversible color-changing composition applied or otherwise associated therewith. Similar to gauge 16, gauge 30 may comprise, in one embodiment, a tape measure 32 supported on a reel 34 with a weight 36 attached to the starting end of tape measure 32. In contrast to tape measure 18 shown in FIGS. 5-10, tape measure 32 comprises a polymer composition 38 configured to reversibly change color upon contact with water, as shown, for example, by the color-changed section of tape 40 in FIG. 4. Thus, gauge 30 is ready to be placed into tank 10 without the addition of any gels, pastes, or other substances to tape 32. Tape 32 generally comprises a flat, substantially flexible, rectangular metal material in at least one embodiment, like tape measure 18 shown in FIGS. 5-10, but tape 32 comprises, in at least one embodiment, a reversible color-changing polymer composition 38 bonded or otherwise attached to the outer surface of tape 32 in such a manner that it cannot be easily removed from tape 32, as shown in FIGS. 3 and 4. In an alternative embodiment, the polymer composition 38 may be embedded in one or more layers or substrates that are thereafter placed on the tape 32. In yet further embodiments, the polymer composition 38 may comprise one or more components placed on different layers or substrates such that the components can reversibly interact with one another across the different layers or substrates.

In the alternative embodiments discussed above, tape 32 may be configured so that the polymer is included within, associated with, or bonded to the material making up the tape itself. In these embodiments, tape 32 may be formed from any material capable of being wound around a reel and generally resistant to crude oil or petroleum. The polymer composition 38 comprises any number of polymers capable of changing color upon contact with water of any temperature but not upon contact with crude oil or petroleum. The polymer is further configured to return to substantially its original starting color after a period of time (a few minutes, for example, but not by way of limitation) of no longer being in direct contact with water.

When the novel tape 32 is retracted from tank 10, an operator can determine a change in color line that spans the entire width of the tape 32 instead of just looking at a strip of gel 26, as shown by a comparison of FIGS. 4 and 8. Thus, an operator can quickly determine at what point on the tape 32 the water meets the oil within tank 10. After a period of time, or after all water on tape 32 is wiped away, tape 32 will return to its substantially starting or substantially original color. At this time, tape 32 can again be lowered into the same or a different tank to determine the presence and amount of water therein. Tape 32 removes the need for any messy gels and also eliminates the potential for operator error when it comes to applying and accurately reading prior art gel 26, thereby increasing operator profits.

Tape 32 disclosed herein may be used instead of any other known measuring tool or water level gauge known in the art, such as gauge 16 shown in FIGS. 5-10. The tape 32 may also be made to any length desired and other geometric shapes, lengths, and style of device may be selected for use as tape 32. For example, but not by way of limitation, tape 32 may be an elongated pole that can be placed into tank 10 and used to determine the presence and amount of water in tank 10.

The tape 32 disclosed herein may also be used in other industrial applications, not just the above-ground storage tanks discussed above. For example, tape 32 may be used to determine water levels within underground storage tanks at gas stations. The tape 32 may also be used to assess water levels within tanks at wastewater treatment centers, within tanks at food processing facilities, in bilge water tanks on marine vessels, in environmental remediation operations (for example, but not by way of limitation, contaminated water wells), and any other industry or instance that requires determining the level of water within a tank containing water and another substance.

Thus, per the present disclosure, a reversible water presence detection and measuring device has been provided. Although the presently disclosed and/or claimed inventive concept(s) has been described in conjunction with the specific language set forth herein above, it is evident that many alternatives, modifications, and variations will be apparent to those skilled in the art. Accordingly, it is intended to embrace all such alternatives, modifications, and variations that fall within the spirit and broad scope of the present disclosure. Changes may be made in the construction of the various components, elements, and assemblies described herein without departing from the spirit and scope of the present disclosure.

What I claim is:

1. A water gauge, comprising:
a tape having measurement lines thereon and wound around a reel, the tape further comprising a reversible color-changing polymer having a first color; and
a weight attached to the end of the tape,
wherein the reversible color-changing polymer changes to a second color upon contact with water and substantially reverts to the first color when the water is no longer in contact with the reversible color-changing polymer.

2. The water gauge of claim 1, wherein the tape further comprises a substantially flat metal strip having the measurement lines inscribed thereon.

3. The water gauge of claim 2, wherein the reversible color-changing polymer is bonded to an outer surface of the tape.

4. The water gauge of claim 2, wherein the reversible color-changing polymer is embedded within the tape.

5. A method of using the water gauge of claim 1, comprising the steps of:
lowering the tape into a tank until the tape reaches a bottom of the tank, the tank containing a mixture of oil and water;
allowing the tape to dwell in the tank for a predetermined period of time;
retracting the tape from the tank after the predetermined period of time;
monitoring the tape to observe where the reversible color-changing polymer substantially assumes the second color; and
determining a measurement of the amount of water in the tank based upon where the reversible color-changing polymer changed to the second color on the tape.

6. The method of claim 5, in which the tank is an above-ground crude oil or petroleum storage tank.

7. The method of claim 5, in which the tank is a wastewater storage tank.

8. The method of claim 5, in which the tank is a bilge water tank on a marine vessel.

9. The method of claim 5, in which the tank is a below-ground crude oil or petroleum storage tank.
